(19) United States
(12) Patent Application Publication
(10) Pub. No.: US 2006/0266293 A1
(43) Pub. Date: Nov. 30, 2006

(54) Medical treatment apparatus and method

(75) Inventors: Eric George Fink, Beaumaris (AU); Gregory Arthur Thomas, Beaumaris (AU); Paul John Dawson, South Melbourne (AU)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Fink Engineering Pty Ltd., Cheltenham (AU)

(21) Appl. No.: 11/417,438

(22) Filed: May 3, 2006

Related U.S. Application Data
(63) Continuation of application No. PCT/AU04/01514, filed on Nov. 1, 2004.

(30) Foreign Application Priority Data
Nov. 3, 2003 (AU) 2003906038

(51) Int. Cl. A01J 3/00

(52) U.S. Cl. 119/14.02

(57) ABSTRACT

A medical apparatus (10) for use in the treatment of an animal. The apparatus (10) includes a chamber (12) for accommodating at least one animal. The chamber (12) includes a first opening (26) for entry of each animal into the chamber (12). The first opening includes a door (30) for sealing the opening (26), such that the inside of the chamber (12) can be subjected to an increased atmospheric pressure relative to the pressure outside the chamber (12). The apparatus (10) also includes a means for increasing the atmospheric pressure within the chamber (12), and a means for supplying oxygen to each animal in the chamber (12) at a greater concentration that that found in air. At least one stall (36) is provided for retaining an animal in a desired position within the chamber (12). A fire deluge system for activation in the event of a fire inside the chamber (12) is also provided. The apparatus (10) further includes at least one hose for connection to a water supply, and at least one drain hole for cleaning the inside of the chamber (12) following a treatment session.

### FIELD OF THE INVENTION

The present invention relates to a method of treatment and apparatus used in that treatment. The present invention has particular application for the treatment of animals and will herein be described generally in that context. However, it is to be appreciated that the invention has broader application and is not limited to that particular use.

### BACKGROUND OF THE INVENTION

The high value and potential earnings of many animals, for example race horses and dogs, places a premium on ensuring their well being. Therefore, there exists a demand from a variety of people, including animal owners, veterinarians, animal handlers, trainers, and the like, for new and/or improved methods for use in the treatment of animals.

Thus, it would be desirable to provide an alternative to the animal treatment methods currently in existence. In particular, it would be desirable to provide an alternative method of treating tissue injuries in animals.

### SUMMARY OF THE INVENTION

In a broad aspect, the present invention provides a medical treatment apparatus for use in the treatment of an animal, including:

a chamber for accommodating at least one animal;

the chamber including a first opening for entry of each animal into the chamber;

the first opening including a door for sealing the opening, such that the inside of the chamber can be subjected to an increased atmospheric pressure relative to the pressure outside the chamber;

a pressure adjustment device for increasing the atmospheric pressure within the chamber;

an oxygen supply device for supplying oxygen to each animal in the chamber at a greater concentration than that found in air;

at least one stall for retaining an animal in a desired position within the chamber;

a fire deluge system for activation in the event of a fire inside the chamber; and

at least one hose for connection to a water supply, and at least one drain hole for cleaning the inside of the chamber following a treatment session.

According to another aspect of the present invention, there is provided a medical treatment apparatus for use in the treatment of an animal, including:

a chamber for accommodating at least one animal;

the chamber including a first opening for entry of each animal into the chamber;

the first opening including a door for sealing the opening, such that the inside of the chamber can be subjected to an increased atmospheric pressure relative to the pressure outside the chamber;

a pressure adjustment device for increasing the atmospheric pressure within the chamber;

an oxygen supply device for supplying oxygen to each animal in the chamber at a greater concentration than that found in air, and

at least one stall for retaining an animal in a desired position within the chamber.

The invention is designed primarily, but not exclusively, for treating animal tissue damaged by disease or injury.

The invention is suitable for the treatment of a wide range of tissue injuries, including bruising, swelling, inflammation, tendonitis, burns, osteomyelitis, infections, wounds and other conditions causing discomfort, dysfunction and/or pain.

The invention is designed to treat an animal by supplying oxygen to the animal's cardiovascular system, while subjecting the animal to an increased atmospheric pressure.

The magnitude of the atmospheric pressure increase in the chamber could be any practical amount. Generally, exposing an animal to atmospheric pressures up 1.5 to 3 atmospheres absolute pressure (ATA) is sufficient to enhance the healing rate of damaged tissue.

The invention may be used in the treatment of a variety of animals, including domesticated animals, livestock and wild animals. In particular, it is envisaged that the invention will be especially suitable for use in the equine industry and for the treatment of dogs. Indeed, race horse trainers, owners, handlers and veterinarians will find the invention most useful in treating a wide variety of tissue injuries, including those sustained by horses and dogs during training, transportation and racing.

The chamber has, so far, generally been described in terms of accommodating one animal at a time. However, it is to be appreciated that the chamber may be designed to accommodate and treat any number of animals. The number of animals able to be accommodated in the chamber will, in part, be dependent on the type of animal to be accommodated, with larger animals such as horses obviously occupying a larger space compared to smaller animals. The number of animals able to be accommodated in the chamber may also, in part, be dependent on any limitations placed on the size of the chamber.

The chamber may be permanently mounted in a desired location. Alternatively, it may be portable, enabling relocation. In the horse racing industry, horses are often moved between various training facilities and racetracks. Thus, portability of the chamber is likely to be of particular benefit to enable the prompt treatment of a horse(s) when and where necessary. As an example, the chamber may be mounted on a truck or semi-trailer tray.

The chamber need only include one opening for an animal(s) to enter the chamber prior to treatment and to exit the chamber once the treatment has been completed. However, particularly in the case of treating larger animals such as horses, the chamber may be provided with separate entry and exit openings disposed on opposite sides of the chamber. This is desirable because it simplifies the removal of an animal from the chamber on completion of treatment. In this respect, a horse to be treated could be led into the chamber through one opening and led from the chamber in the same direction through a second, oppositely disposed chamber opening.

A means for sealing each of the chamber openings may be provided in the form of a door or other closure, allowing the inside of the chamber to be subjected to an increased atmospheric pressure relative to the atmospheric pressure outside the chamber.

The chamber could be of any practical size and shape. The chamber may include, for example, a rectangular or square floor plan, with the overall 3-dimensional shape of the chamber being a rectangular parallelepiped (cuboid) or cube shape. One advantage of the chamber being regularly shaped is that it can be more easily incorporated into and/or located within a building, rather than having to especially design or re-design a room or area to house the chamber. It is to be appreciated, however, that the chamber could adopt any other suitable shape, whether regular or irregular. The chamber may be sized and shaped to suit a certain type, size and number of animals.

The provision of at least one stall assists in manoeuvring and retaining each animal in the desired location and orientation within the chamber during treatment. The stall(s) also provide a safety aspect to the chamber by preventing injury of an animal or person during treatment. The stall(s) also assist in manoeuvring animals into and out of the chamber. Each stall may be provided with one or more gates or movable barriers.

Preferably, the oxygen supply means is capable of supplying (practically speaking) pure oxygen to each animal being treated in the chamber.

In a preferred form, the means for supplying oxygen includes a respective mask, hood or similar provided for each animal within the chamber. It is envisaged that each the mask, hood or similar would be connected to an oxygen supply via a conduit.

The oxygen supply may be in the form of pressurised oxygen from oxygen cylinders or a liquid oxygen supply.

The pressure adjustment device for increasing the atmospheric pressure within the chamber may include a source of compressed air from air cylinders or more likely a low pressure air compressor complete with filtration to provide breathing quality air for chamber pressurisation. Management of the chamber pressure may be accomplished by valving operated manually or automatically from a control panel that also indicates chamber pressure.

In another broad aspect, the invention is directed to a medical treatment method for use in the treatment of an animal, including:

placing at least one animal in a stall within a chamber via a first chamber opening;

closing a gate provided on the stall;

sealing the chamber;

increasing the atmospheric pressure inside the chamber relative to the atmospheric pressure outside the chamber;

causing the at least one animal in the chamber to breathe oxygen at a concentration greater than that found in air for a period of time;

reducing the oxygen concentration breathed by an animal to approximately that found in air;

reducing the atmospheric pressure within the chamber to approximately the atmospheric pressure level outside the chamber;

opening the stall gate and removing the at least one animal from the stall and chamber.

According to another broad aspect, the invention is directed to a medical treatment method for use in the treatment of an animal, including:

placing at least one animal in a chamber via a first chamber opening, placing the at least one animal within a stall provided within the chamber;

sealing the chamber;

increasing the atmospheric pressure inside the chamber relative to the atmospheric pressure outside the chamber;

causing the at least one animal in the chamber to breathe oxygen at a concentration greater than that found in air for a period of time;

reducing the oxygen concentration breathed by an animal to approximately that found in air;

reducing the atmospheric pressure within the chamber to approximately the atmospheric pressure level outside the chamber;

removing the at least one animal from the stall and chamber.

The methods described above may be repeated to provide a plurality of discrete and separate treatment sessions.

The methods may be used to concurrently treat more than one animal within the chamber.

It is envisaged that the supply of oxygen to each animal will be carefully controlled, such that the oxygen will be supplied for a predetermined period of time, or until an animal exhibits any adverse side effects.

It will be convenient to hereinafter describe preferred embodiments of the invention with reference to the accompanying drawings. The particularity of the drawings is to be understood as not limiting the preceding broad description of the invention.

### BRIEF DESCRIPTION OF THE DRAWINGS

In the drawings:

FIG. 1 is a perspective front view of an apparatus according to an embodiment of the invention;

FIG. 2 is a sectional plan view of the apparatus illustrated in FIG. 1;

FIG. 3 is a sectional rear view of the apparatus illustrated in FIG. 1;

FIG. 4 is a sectional perspective view of the apparatus illustrated in FIG. 1;

FIG. 5 is a sectional front view of an apparatus according to another embodiment of the invention;

FIG. 6 is a sectional perspective view of the apparatus illustrated in FIG. 5;

FIG. 7 is another perspective view of the apparatus illustrated in FIG. 5;

FIG. 8 is a sectional view of FIG. 7;

FIG. 9 is a sectional plan view of an apparatus according to another embodiment of the invention;

FIG. 10 is a sectional side view of the apparatus illustrated in FIG. 9;

FIG. 11 is a sectional front view of the apparatus illustrated in FIG. 9;

FIG. 12 is a side view of the apparatus illustrated in FIG. 9.

### DESCRIPTION OF PREFERRED EMBODIMENTS

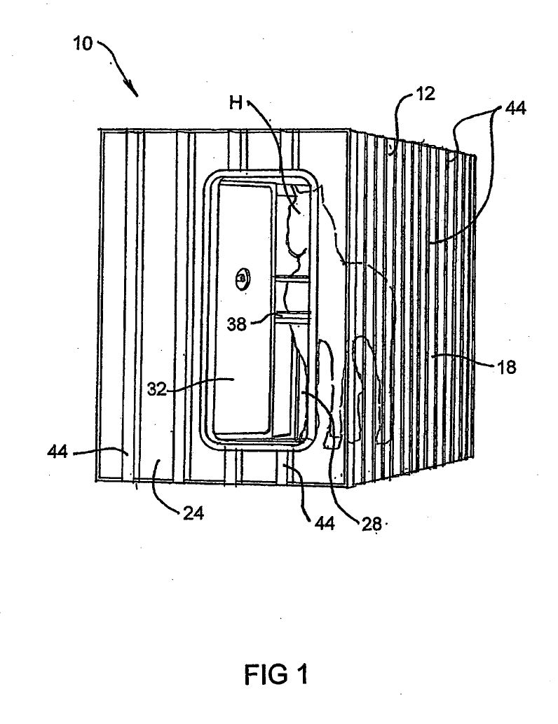

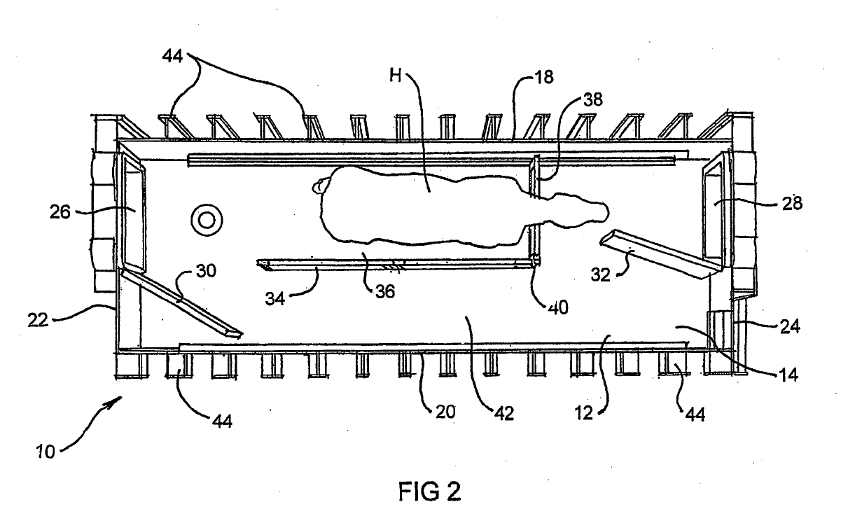

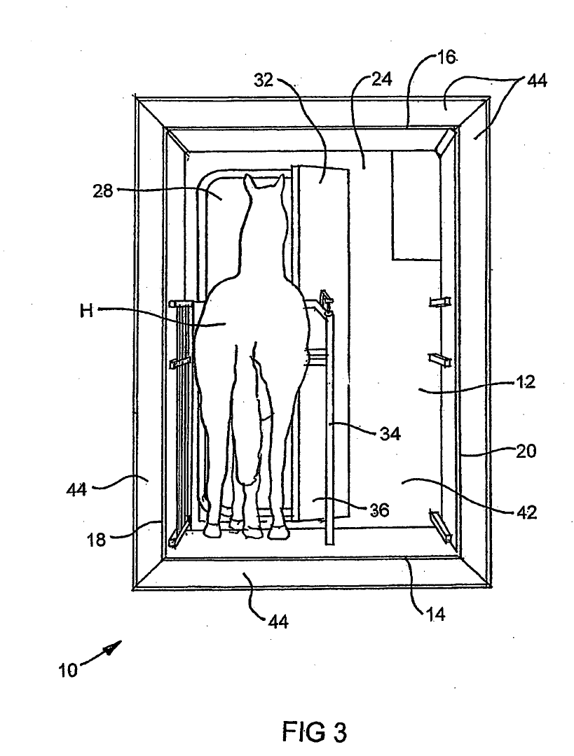

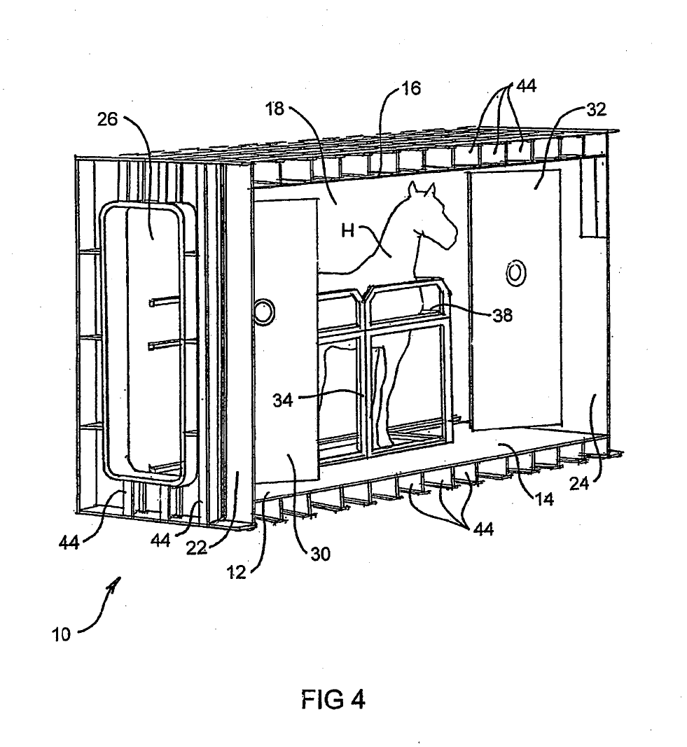

Referring to FIGS. 1 to 4, there is illustrated a medical treatment apparatus 10. The apparatus 10 is designed especially, but not exclusively, for the treatment of animals and particularly for the treatments of horses. A horse H is illustrated in order to assist with an understanding of the invention.

The apparatus 10 includes a chamber 12. The chamber 12 is designed specifically for treating one horse at a time. The chamber 12 includes a rectangularly shaped floor 14, a ceiling 16, sidewalls 18,20 and end walls 22,24. The overall 3-dimensional shape of the chamber 12 is generally that of a rectangular parallelepiped (or cuboid). It is to be appreciated, however, that the chamber 12 could be any other practical shape. The chamber is manufactured to meet the requirements of a nationally recognised pressure vessel code such as AS1210, ASME or suitable equivalent. It is to be appreciated that the chamber 12 may be of a different size and/or shape for accommodating other types of animals besides horses. If the apparatus 10 is to be used for the treatment of, for example dogs, then it is to be appreciated that the chamber could be manufactured in a smaller size.

The end wall 22 includes an opening 26, in the form of a doorway, for entry of the horse H into the chamber 12. A second opening 28, also in the form of a doorway, is provided in the end wall 24 for removal of the horse H from the chamber 12 once treatment has been completed. The openings 26,28 are oppositely disposed in the chamber 12 in order to simplify manoeuvring of the horse H into and from the chamber 12. In this respect, it is possible to lead the horse H in the one direction through opening 26 and into the chamber 12 and then, once a treatment session has been completed, in the same direction out the opening 28.

A means for sealing the openings 26,28 is provided, including respective steel doors 30,32. The door 30 is hingedly connected to the opening 26, while the door 32 is hingedly connected to the opening 28. Seals (not illustrated) are provided between the openings 26,28 and the respective doors 30,32, such that (with the doors 30,32 closed) the inside of the chamber 12 can be subjected to an increased atmospheric pressure relative to the pressure outside of the chamber 12.

Alternatively, it is possible to have the doors 30,32 hinge externally and be designed such that they will contain the internal chamber pressure by way of a suitable pressure retaining closure.

Steel railings 34 define a stall 36 for accommodating the horse H within the chamber 12. The stall 36 includes a gate 38 illustrated in the closed position. The gate 38 is pivotally connected to an upright 40.

An area 42 is provided within the chamber 12 for accommodating one or more persons overseeing treatment of the horse H whilst the chamber is unpressurised. The area 42 may also be utilised for accommodating the equipment necessary for treatment of the horse H.

An oxygen supply device (not illustrated) for supplying oxygen to the horse H is provided. Oxygen is supplied from high pressure oxygen cylinders and/or a liquid oxygen tank via a regulator which reduces the supply pressure to 10 BAR. The oxygen is then routed to a control console where the flow can be regulated by way of a flowmeter before it is routed into the chamber to a built in breathing system (BIBS) connection. From this connection a flexible hose is attached to a BIB mask which fits over the horse's mouth and nose to enable it to breathe oxygen. The exhaled gas is then routed via another flexible hose to an exhaust BIBS connection which is routed to a chamber exhaust plenum where it leaves the chamber through a chamber exhaust valve.

The rate of healing of a tissue damaged by disease or injury is largely dependent on and limited by the availability of oxygen supplied to the cardiovascular system of the animal concerned. Thus, the oxygen supply device is able to provide an increase in the rate of oxygen supplied to the cardiovascular system of an animal compared to that available when the animal breathes air. This increased oxygen supply rate has been found to increase the healing rate of damaged tissue when supplied at increased atmospheric pressure.

Accordingly, a pressure adjustment device (not illustrated) for increasing the atmospheric pressure within the chamber 12 is provided in the form of a compressor or a pressurised gas storage system. It is envisaged that the means would enable the atmospheric pressure within the chamber 12 to be increased relative to the atmospheric pressure outside of the chamber 12 by anywhere from (typically) 1.5 ATA to 3 ATA. However, this range is provided for illustrative purposes only and so the actual atmospheric pressure within the chamber 12 may be increased a greater or lesser amount.

The chamber 12 may be permanently located. However, the chamber 12 has been specifically designed to be portable. Reinforcing beams 44 (only some of which are labelled) are provided along the outside of the walls 18,20,22,24, ceiling 16 and floor 14 to assist in pressure containment and to protect the chamber 12 from damage during transit. The chamber 12 may be mounted on a truck or semi-trailer tray.

In operation, the horse H is lead through the opening 26 and into the stall 34 provided in chamber 12. The door 30 is closed. If not already closed, the door 32 is also closed. A bib or hood (again, not illustrated) is fitted to the head and/or nose and/or mouth of the horse H. The atmospheric pressure within the chamber 12 is increased to anywhere from 1.5 ATA to 3 ATA (nominal 2.5 ATA). Following this, oxygen is supplied to the horse H from an oxygen supply (again, not illustrated) via a conduit to the bib or hood. The overall oxygen supply time may be selected to suit a specific animal and injury being treated. Overall treatment times may vary from 90 to 150 minutes, but may fall outside of this range. The overall treatment time may include two or more separate treatment sessions. The horse H may be removed from the chamber 12 between treatment sessions, depending on the length of time between sessions and the comfort of the horse H.

Once treatment is finished, the bib or mask can be removed from the horse H and the chamber 12 decompressed to reduce the atmospheric pressure within the chamber 12 to that of the atmospheric pressure outside the chamber 12. The gate 38 and door 32 can then be opened and the horse H can be led from the chamber 12 through the opening 28.

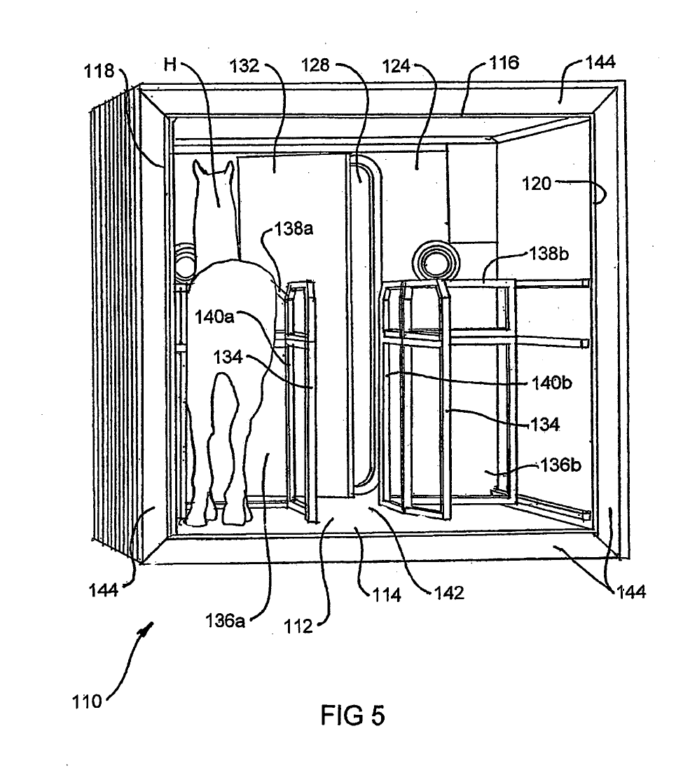

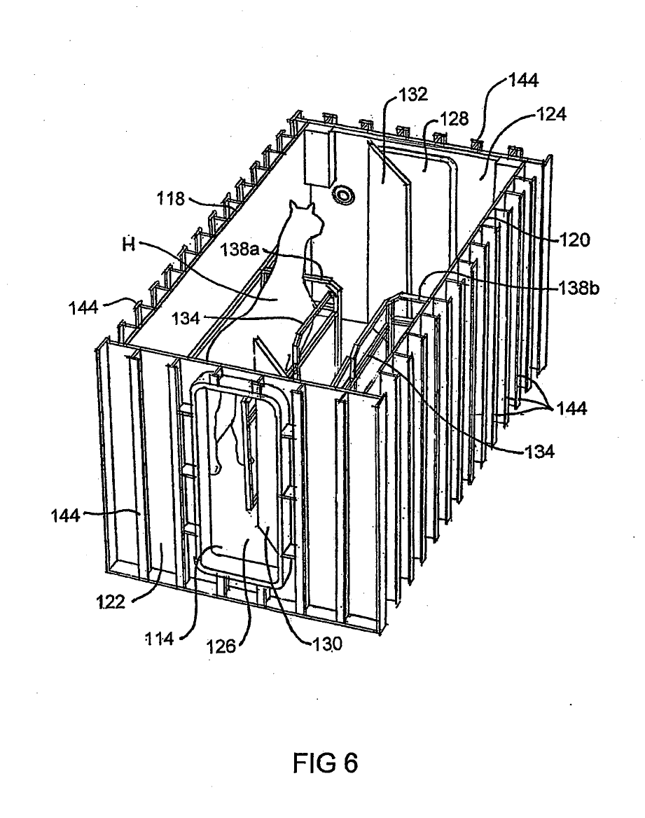

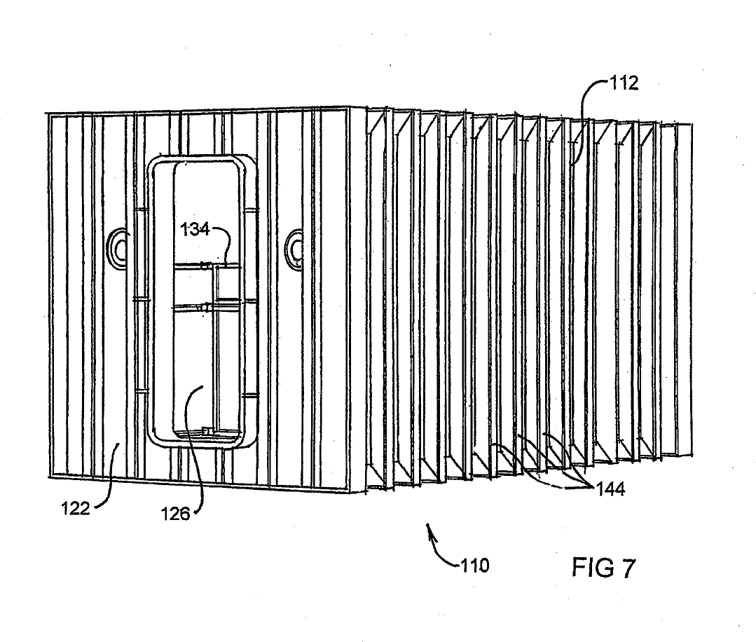

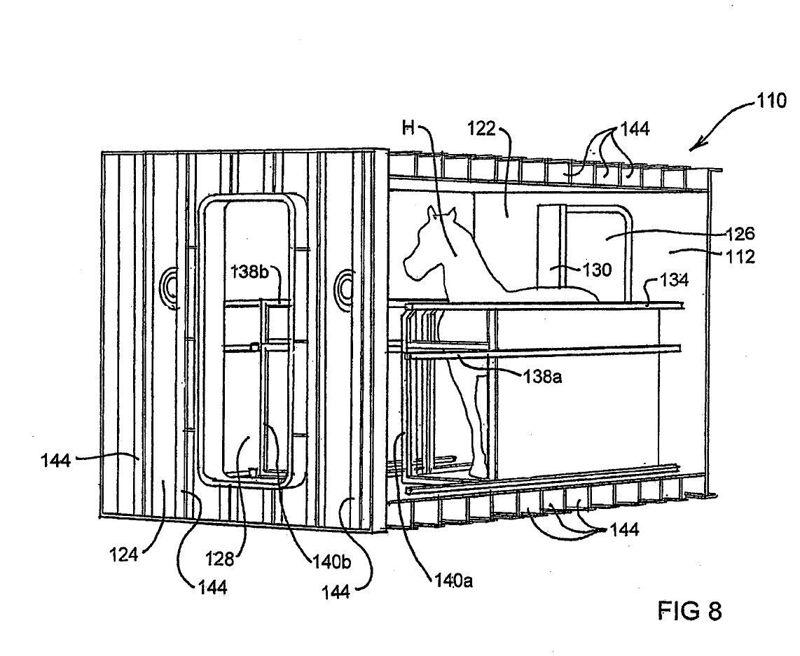

Referring to FIGS. 5 to 8, another medical treatment apparatus 110 is illustrated.

The apparatus 110 includes a chamber 112, having a rectangularly shaped floor 114, ceiling 116, sidewalls 118,120 and end walls 122,124.

An opening 126, in the form of a doorway, is provided in the end wall 122. Another opening 128, again in the form of a doorway, is provided in the end wall 124. The opening 126 is provided for the horse(s) H to enter the chamber 112 for treatment, while the opening 128 is provided for the horse(s) H to exit the chamber 112 upon completion of treatment or a treatment session.

Means for sealing the openings 126,128 are provided, including respective steel doors 130,132. The door 130 is hinged to the opening 126, while the door 132 is hinged to the opening 128. Seals (not illustrated) are provided between the openings 126,128 and the respective doors 130,132, such that (with the doors 130,132 closed) the inside of the chamber 112 can be subjected to an increased atmospheric pressure relative to the pressure outside of the chamber 112.

The chamber 112 includes railings 134 that define two stalls 136a,b. This allows for the possibility of concurrent treatment of two horses, only one of which is illustrated in the stall 136a.

Each of the stalls 136a,b includes a gate 138a,b (both shown in the closed position). Each gate 138a,b is pivotally connected to an upright 140a,b.

The provision of two stalls 136a,b provides a centrally located area 142 to accommodate one or more persons (whilst the chamber 112 is unpressurised) and/or equipment.

Separate hoods and/or masks (not illustrated) may be provided for treating two horses concurrently. Each hood and/or mask may be connected via a conduit to an oxygen supply tank.

A pressure adjustment device (not illustrated) for increasing the atmospheric pressure within the chamber 112 is provided in the form of a compressor or a pressurised gas storage system. The operation and function of the pressure increasing means of the embodiment illustrated in FIGS. 5 to 8 is similar that that of the embodiment illustrated in FIGS. 1 to 4.

Reinforcing beams 144 (only some of which are labelled) are provided along the outside of each of the walls 118,120,122,124, the ceiling 116 and the floor 114.

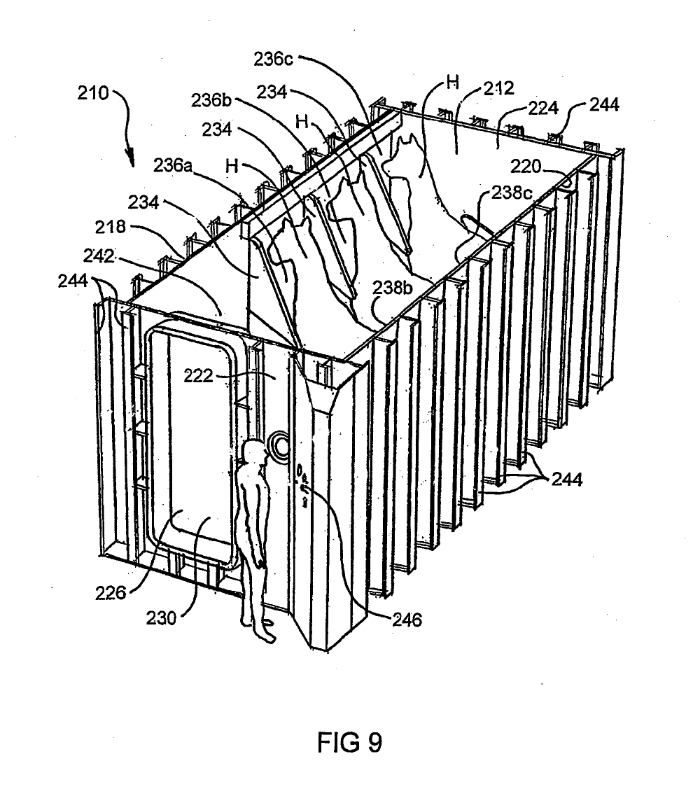

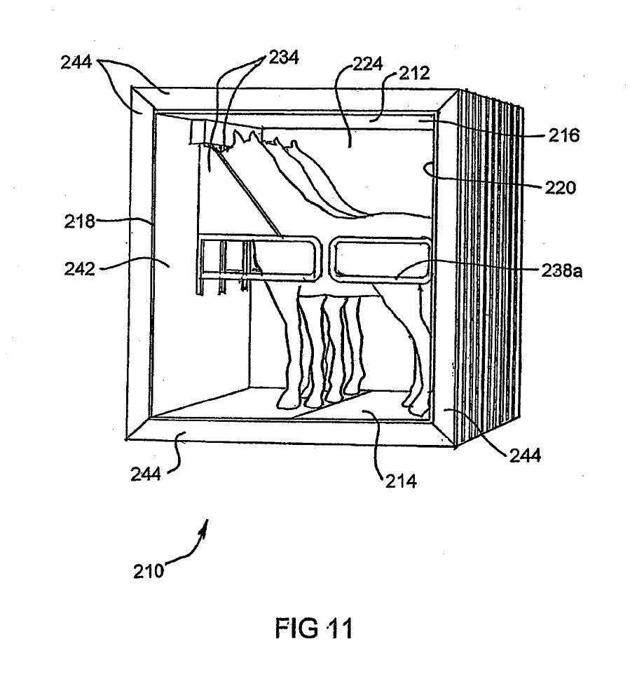

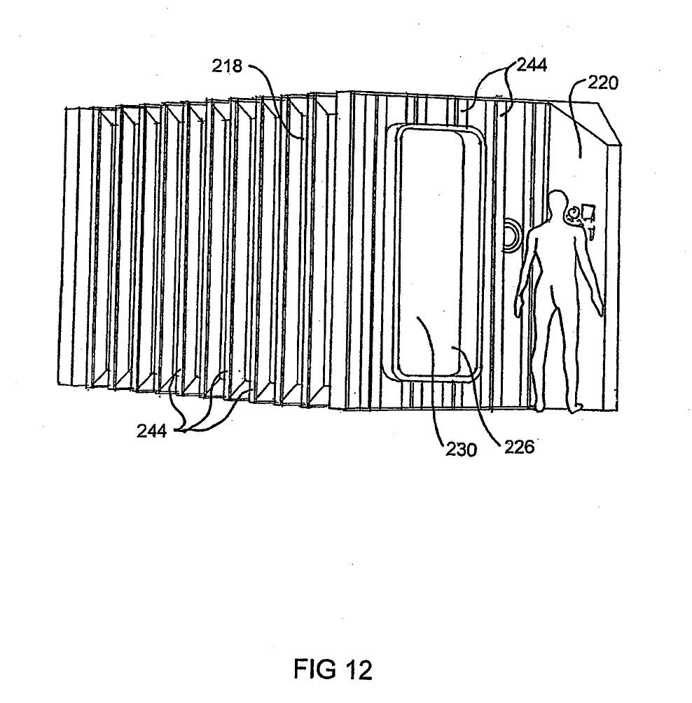

Yet another medical treatment apparatus 210 is illustrated in FIGS. 9 to 12.

The apparatus 210 includes a chamber 212, having a rectangularly shaped floor 214, ceiling 216, sidewalls 218, 220 and end walls 222, 224.

A single opening 226, in the form of a door way, is provided in the end wall 222. The opening 226 is provided for the horse(s) H to enter the chamber 212 for treatment, and to also exit the chamber 212 upon completion of treatment or a treatment session.

Means for sealing the opening 226 is provided in the form of a steel door 230, which is hinged to the opening 226. Seals (not illustrated) are provided between the opening 226 and the door 230, such that (with the door 230 closed) the inside of the chamber can be subjected to an increased atmospheric pressure relative to the outside of the chamber 212.

The chamber 212 includes dividers 234 that define three stalls 236a, b, c. This allows for the possibility of treating three horses simultaneously.

Each of the stalls 236a, b, c includes a gate 238a, b, c (each illustrated in the closed position). Each gate 238a, b, c is pivotally connected to the inside of side wall 220.

An area 242 is provided for accommodating one or more persons (whilst the chamber 212 is unpressurised) and/or equipment.

Separate hoods and/or masks (not illustrated) may be provided for treating three horses simultaneously. Each hood and/or mask may be connected via a conduit to an oxygen supply tank.

A pressure adjustment device (not illustrated) for increasing the atmospheric pressure within the chamber 212 is provided in the form of a compressor or a pressurised gas storage system. The operation and function of the pressure adjustment device of the embodiment illustrated in FIGS. 9 to 12 is similar to that of the embodiment illustrated in FIGS. 1 to 4.

Reinforcing beams 244 (only some of which are labelled) are provided along the outside of each of the walls 218, 220, 222, 224 the ceiling 216 and floor 214.

Although not illustrated, it is to be appreciated that the dimensions and/or layout of the chamber 12/112/212 may be altered to accommodate a greater number of horses, if desired. Similarly, the chamber 12/112/212 dimensions and/or layout may be altered to provide for the treatment of other animal species, if desired. Alterations of this nature may necessitate a greater number and possible redesign of the hoods and/or masks used in the chamber.

The controls (not illustrated) for pressurisation and depressurisation can be of any suitable form, including manual ball valves, and a more sophisticated design whereby the pressure can be ramped up and down by a PID controller driven from a touch screen with appropriate software.

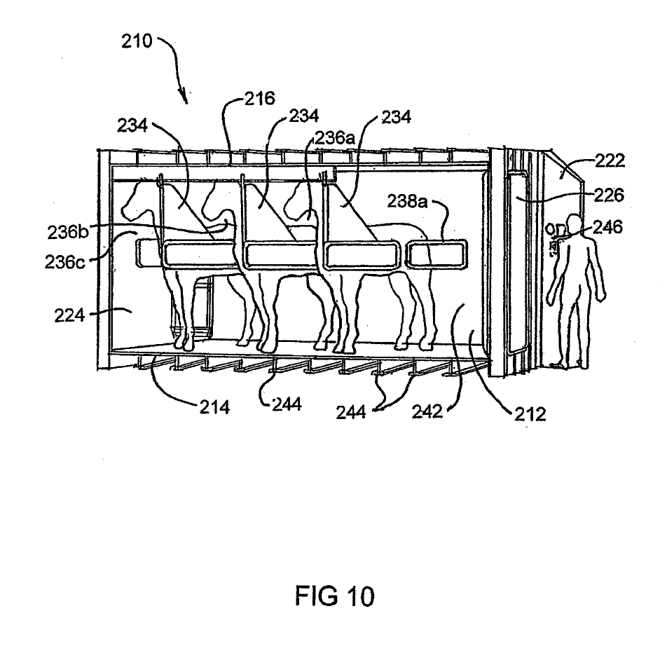

A fire deluge system (not illustrated) is provided to cover the possibility of a fire inside the chamber and will be actuated manually by the chamber operator who can watch the horses via a TV screen or through the view port located by the console 246 (see FIGS. 9 and 10). Hand held hoses can be used for cleaning (by hosing) the chamber by flushing the contents down a drain hole (not illustrated) located in the corner of the chamber.

Lighting can be provided either internally using explosion proof light fittings or externally by shining an external light through a light port (similar to a view port).

Finally, it is to be understood that various alterations, modifications and/or additions may be introduced into the construction and arrangement of the parts, and method previously described without departing from the spirit or ambit of this invention.

1. A medical treatment apparatus for use in the treatment of an animal, comprising:
a chamber for accommodating at least one animal;
the chamber comprising a first opening for entry of each animal into the chamber;
the first opening comprising a door for sealing the opening, such that the inside of the chamber can be subjected to an increased atmospheric pressure relative to the pressure outside the chamber;
a pressure adjustment device for increasing the atmospheric pressure within the chamber;
an oxygen supply device for supplying oxygen to each animal in the chamber at a greater concentration than that found in air;
at least one stall for retaining an animal in a desired position within the chamber;
a fire deluge system for activation in the event of a fire inside the chamber; and
at least one hose for connection to a water supply, and at least one drain hole for cleaning the inside of the chamber following a treatment session.

2. A medical treatment apparatus for use in the treatment of an animal, comprising:
a chamber for accommodating at least one animal;
the chamber comprising a first opening for entry of each animal into the chamber;
the first opening comprising a door for sealing the opening, such that the inside of the chamber can be subjected to an increased atmospheric pressure relative to the pressure outside the chamber;
a pressure adjustment device for increasing the atmospheric pressure within the chamber;
an oxygen supply device for supplying oxygen to each animal in the chamber at a greater concentration than that found in air, and
at least one stall for retaining an animal in a desired position within the chamber.

3. A medical treatment apparatus according to claim 2, wherein each stall comprises a gate.

4. A medical treatment apparatus according to claim 2, wherein the chamber comprises a fire deluge system for activation in the event of a fire inside the chamber.

5. A medical treatment apparatus according to claim 2, wherein the chamber comprises:
at least one hose for connection to a water supply, and at least one drain hole for cleaning the inside of the chamber following a treatment session.

6. A medical treatment apparatus according to claim 2, wherein the pressure adjustment device for increasing the atmospheric pressure is capable of a pressure increase within the chamber of between 1.5 and 3 atmospheres absolute pressure (ATA).

7. A medical treatment apparatus according to claim 2, wherein the chamber comprises a plurality of stalls for accommodating a plurality of animals.

8. A medical treatment apparatus according to claim 2, wherein the apparatus is portable.

9. A medical treatment apparatus according to claim 8, wherein the apparatus is mountable on at least one of a truck or semi-trailer tray.

10. A medical treatment apparatus according to claim 2, wherein the oxygen supply device is capable of supplying substantially pure oxygen from an oxygen supply to each animal being treated in the chamber.

11. A medical treatment apparatus according to claim 10 wherein the supply of oxygen to each animal is via one of a mask and hood that fits over the mouth and nose of the animal and which is connected to the oxygen supply via a conduit.

12. A medical treatment apparatus according to claim 2, wherein the oxygen supply device comprises at least one of an oxygen cylinder and a liquid oxygen supply.

13. A medical treatment apparatus according to claim 2, wherein the oxygen supply device comprises a control console for regulating the supply of oxygen to each animal being treated.

14. A medical treatment apparatus according to claim 2, wherein the chamber comprises an area for accommodating at least one person overseeing treatment of the at least one animal.

15. A medical treatment apparatus according to claim 2, comprises pressurisation and depressurisation controls including at least one of manual ball valves, and a PID controller driven from a touch screen with appropriate software.

16. A medical treatment apparatus according to claim 2, wherein the apparatus is for the treatment of at least one of a horse and a dog.

17. A medical treatment apparatus according to claim 2, wherein the chamber comprises a second opening having a second door, the second opening disposed within the chamber walls approximately opposite the first opening, the second opening provided for removal of each animal from within the chamber.

18. A medical treatment method for use in the treatment of an animal, comprising:
placing at least one animal in a stall within a chamber via a first chamber opening;
closing a gate provided on the stall;
sealing the chamber;
increasing the atmospheric pressure inside the chamber relative to the atmospheric pressure outside the chamber;
causing the at least one animal in the chamber to breathe oxygen at a concentration greater than that found in air for a period of time;
reducing the oxygen concentration breathed by an animal to approximately that found in air;
reducing the atmospheric pressure within the chamber to approximately the atmospheric pressure level outside the chamber;
opening the stall gate and removing the at least one animal from the stall and chamber.

19. A medical treatment method for use in the treatment of an animal, comprising:
placing at least one animal in a chamber via a first chamber opening, placing the at least one animal within a stall provided within the chamber;
sealing the chamber;
increasing the atmospheric pressure inside the chamber relative to the atmospheric pressure outside the chamber;
causing the at least one animal in the chamber to breathe oxygen at a concentration greater than that found in air for a period of time;
reducing the oxygen concentration breathed by an animal to approximately that found in air;
reducing the atmospheric pressure within the chamber to approximately the atmospheric pressure level outside the chamber;
removing the at least one animal from the stall and chamber.

20. A medical treatment method according to claim 19, wherein removal of the at least one animal from the chamber comprises removing the animal through a second opening having a door, the second opening disposed within the chamber walls approximately opposite the first opening.

21. A medical treatment method according to claim 19, wherein the method is repeated to provide a plurality of discrete and separate treatment sessions.

22. A medical treatment method according to claim 19, wherein the method is used to concurrently treat a plurality of animals, with each animal accommodated within a separate stall within the chamber.

23. A medical treatment method according to claim 19, wherein oxygen is supplied to each animal for a predetermined period of time.

24. A medical treatment method according to claim 19, wherein the supply of oxygen to an animal is terminated when the animal exhibits adverse side effects.

25. A medical treatment method according to claim 19, wherein the atmospheric pressure within the chamber is increased to between about 1.5 and 3 ATA.

26. A medical treatment method according to claim 19, wherein oxygen is supplied to each animal for between about 90 and 150 minutes during each treatment session.

27. A medical treatment method according to claim 19, wherein the supply of oxygen to each animal comprises the placement of one of a mask and hood over the mouth and nose of the animal.

28. A medical treatment method according to claim 19, wherein each stall comprises a gate, and wherein the gate of each stall containing at least one animal is closed prior to a treatment session.
